(19) United States
(12) Patent Application Publication
(10) Pub. No.: US 2025/0355173 A1
(43) Pub. Date: Nov. 20, 2025

(54) POLYMER OPTICAL WAVEGUIDE AND OPTICAL WAVEGUIDE COMPONENT

(71) Applicant: SHINKO ELECTRIC INDUSTRIES CO., LTD., Nagano (JP)

(72) Inventor: Kenji YANAGISAWA, Nagano (JP)

(21) Appl. No.: 19/197,080

(22) Filed: May 2, 2025

(30) Foreign Application Priority Data
May 17, 2024 (JP) 2024-080794

(51) Int. Cl. G02B 6/122; G02B 6/12

(52) U.S. Cl. CPC G02B 6/122; G02B 2006/12069

(57) ABSTRACT

A polymer optical waveguide includes a core having an end surface, and a cladding provided around the core and having a first surface, wherein a recess is formed in the first surface. The end surface is exposed inside the recess, and the end surface is located at a position deeper than the first surface.

### CROSS-REFERENCE TO RELATED APPLICATIONS

This application is based upon and claims priority to Japanese Patent Application No. 2024-080794, filed on May 17, 2024, the entire contents of which are incorporated herein by reference.

### FIELD

Certain aspects of the embodiments discussed herein are related to polymer optical waveguides, optical waveguide components, and methods for manufacturing polymer optical waveguides.

### BACKGROUND

Various techniques have been proposed for optical waveguide components having an optical waveguide provided on a substrate. An optical fiber is optically coupled to the optical waveguide.

Related art include Japanese Laid-Open Patent Publication No. 2014-059479, and Japanese Laid-Open Patent Publication No. H11-281846, for example.

It is difficult to obtain a high coupling efficiency between the optical waveguide and the optical fiber according to conventional techniques.

### SUMMARY

Accordingly, it is an object in one aspect of the present disclosure to provide a polymer optical waveguide, an optical waveguide component, and a method for manufacturing the polymer optical waveguide, which can obtain a high coupling efficiency between the optical waveguide and an optical fiber.

According to one aspect of the present disclosure, a polymer optical waveguide includes a core having an end surface; and a cladding provided around the core and having a first surface, wherein a recess is formed in the first surface, the end surface is exposed inside the recess, and the end surface is located at a position deeper than the first surface.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1A and FIG. 1B are diagrams illustrating an example of an optical waveguide according to a first embodiment;

FIG. 2A and FIG. 2B are cross sectional views illustrating an example of a method for manufacturing the optical waveguide according to the first embodiment;

FIG. 3A and FIG. 3B are diagrams illustrating an example of the optical waveguide according to a second embodiment;

FIG. 4A and FIG. 4B are cross sectional views (part 1) illustrating an example of the method for manufacturing the optical waveguide according to the second embodiment;

FIG. 5A and FIG. 5B are cross sectional views (part 2) illustrating the example of the method for manufacturing the optical waveguide according to the second embodiment;

FIG. 6A and FIG. 6B are cross sectional views illustrating an example of the optical waveguide component according to a third embodiment; and

FIG. 7A and FIG. 7B are cross sectional views illustrating an example of use of the optical waveguide component according to the third embodiment.

### DESCRIPTION OF EMBODIMENTS

Hereinafter, embodiments of the present disclosure will be described in detail with reference to the accompanying drawings. In the specification and the drawings, constituent elements having substantially the same functional configuration are designated by the same reference numerals, and a redundant description thereof may be omitted.

### First Embodiment

A first embodiment will be described. The first embodiment relates to an optical waveguide.

### [Configuration of Optical Waveguide]

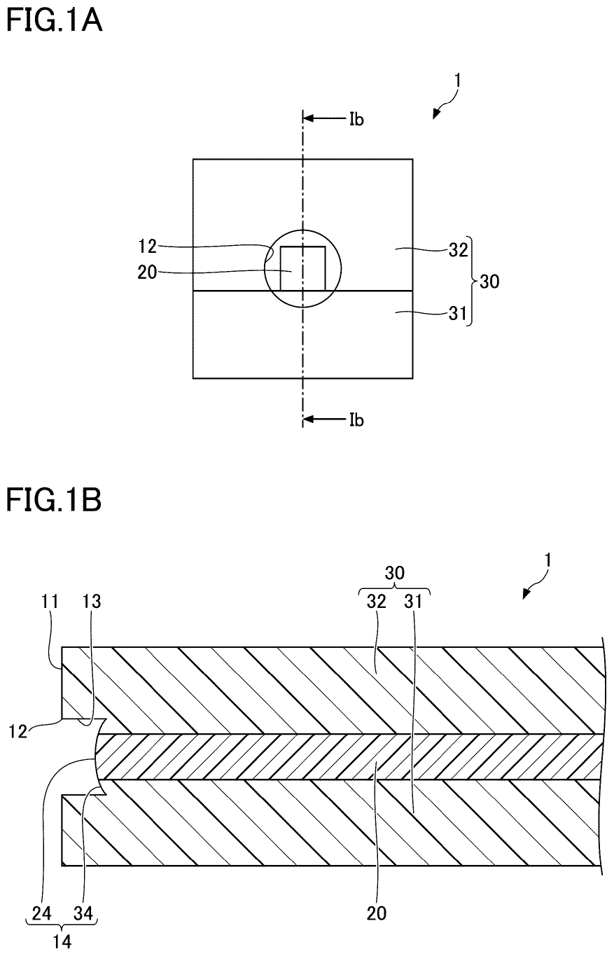

A configuration of an optical waveguide according to the first embodiment will be described. FIG. 1A and FIG. 1B are diagrams illustrating an example of the optical waveguide according to the first embodiment. FIG. 1A illustrates a side view of the optical waveguide, and FIG. 1B illustrates a cross sectional view of the optical waveguide. FIG. 1B corresponds to a cross sectional view taken along a line Ib-Ib in FIG. 1A.

As illustrated in FIG. 1A and FIG. 1B, a polymer optical waveguide 1 according to the first embodiment includes a core 20, and a cladding 30. The core 20 extends linearly, and has an end surface 24. The cladding 30 is provided around the core 20, and has a first surface 11. The cladding 30 includes a first cladding layer 31, and a second cladding layer 32. The polymer optical waveguide 1 may include a plurality of cores 20.

In the present embodiment, the first cladding layer 31 is used as a reference for the sake of convenience. That is, the side of the polymer optical waveguide 1 provided with the second cladding layer 32 with reference to the first cladding layer 31 will be referred to as an upper side or one side, and the opposite side of the polymer optical waveguide will be referred to as a lower side or the other side. In addition, a surface of an upper side of each portion will be referred to as one surface or an upper surface, and a surface of a lower side of each portion will be referred to as the other surface or a lower surface. However, the polymer optical waveguide 1 can be used in an upside-down state or can be arranged at an arbitrary angle.

A material used for the first cladding layer 31 is an organic resin, such as an epoxy resin, a polyimide resin, or the like, for example. A thickness of the first cladding layer 31 is in a range of approximately 10 μm to approximately 30 μm, for example.

The core 20 is provided on the first cladding layer 31. A material used for the core 20 is an organic resin, such as an epoxy resin, a polyimide resin, or the like, for example. A cross sectional shape of the core 20 perpendicular to the extending direction of the core 20 is a rectangular shape, for example. In order to obtain a single-mode optical waveguide, the core 20 may have a small cross sectional area. A width of the core 20 is in a range of 5 μm to 10 μm, and a height of the core 20 is in a range of 5 μm to 10 μm, for example.

The second cladding layer 32 is provided on the first cladding layer 31 and the core 20. The second cladding layer 32 covers the core 20. A material used for the second cladding layer 32 is an organic resin, such as an epoxy resin, a polyimide resin, or the like, for example. A thickness of the second cladding layer 32 is in a range of approximately 10 μm to approximately 30 μm, for example.

In the polymer optical waveguide 1, a refractive index of the core 20 is higher than refractive indexes of the first cladding layer 31 and the second cladding layer 32.

The first surface 11 is perpendicular to the extending direction of the core 20. A recess 12 is formed in the first surface 11. The end surface 24 of the core 20 is exposed inside the recess 12. The end surface 24 is located at a position deeper than the first surface 11. In a plan view from above a direction perpendicular to the first surface 11, the recess 12 has a circular shape. A diameter of the recess 12 is in a range of approximately 8 μm to approximately 15 μm, for example. A depth of the recess 12 is in a range of approximately several μm to approximately several tens of μm, for example. In the plan view from above in the direction perpendicular to the first surface 11, the end surface 24 is separated from a sidewall surface 13 of the recess 12 and is located on an inner side the sidewall surface 13. In the plan view from above in the direction perpendicular to the first surface 11, a center of the recess 12 may coincide with a center of the end surface 24.

A bottom surface 14 of the recess 12 includes the end surface 24, and a surface 34 of the cladding 30 continuous with the end surface 24. The end surface 24 is preferably a convex surface, and the entire bottom surface 14 may be a convex surface.

As described above, in the polymer optical waveguide 1, the end surface 24 is located at a position deeper than the first surface 11. An optical fiber supported by a support member, such as an optical connector or the like, is optically coupled to the polymer optical waveguide 1. In this state, the support member is in contact with the first surface 11, but the optical fiber does not contact the end surface 24. For this reason, a distortion of the core 20 due to the contact with the end surface 24 of the optical fiber can be prevented, a deterioration of a coupling loss due to the distortion of the core 20 can be prevented, and a high coupling efficiency can be obtained between the polymer optical waveguide 1 and the optical fiber.

Further, because the end surface 24 is a convex surface, a high light condensing performance is obtained between the end surface 24 and an end surface of the optical fiber. Accordingly, it is possible to improve the coupling efficiency between the polymer optical waveguide 1 and the optical fiber.

### [Method for Manufacturing Optical Waveguide]

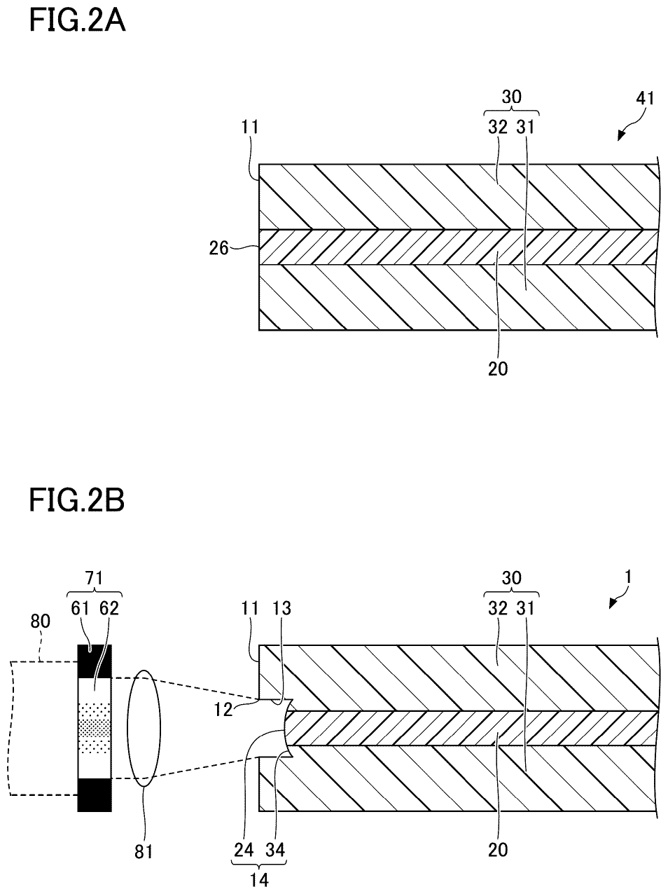

A method for manufacturing the polymer optical waveguide 1 will be described. FIG. 2A and FIG. 2B are cross sectional views illustrating the method for manufacturing the optical waveguide according to the first embodiment.

First, as illustrated in FIG. 2A, an intermediate structure 41, including the cladding 30 having the first surface 11 and the core 20 having a second surface 26, is formed. Specifically, the core 20 is formed on the first cladding layer 31, and the second cladding layer 32 is formed on the first cladding layer 31 and the core 20. In the intermediate structure 41, the cladding 30 is provided around the core 20. For example, the first surface 11 and the second surface 26 coincide with each other.

Next, as illustrated in FIG. 2B, the recess 12 is formed in the intermediate structure 41. When forming the recess 12, the first surface 11 and the second surface 26 are irradiated with a laser beam 80 through a glass mask 71 and a convex lens 81. For example, an excimer laser beam is used for the laser beam 80. The glass mask 71 includes an annular optically opaque portion (or light blocking portion) 61, and an optically transparent portion (or light transmitting portion) 62 on an inner side of the opaque portion 61. A light transmittance is not uniform in the transparent portion 62, and the light transmittance is lower at positions closer to a center and higher at positions closer to the opaque portion 61. The first surface 11 and the second surface 26 are irradiated with the laser beam 80 through the glass mask 71 and the convex lens 81, thereby forming the recess 12 having the convex bottom surface 14. For example, the laser beam 80 is irradiated on the entire second surface 26 and on a portion of the first surface 11.

The polymer optical waveguide 1 according to the first embodiment can be manufactured by the processes described above.

In this manufacturing method, the end surface 24 is formed by irradiating the laser beam 80. For this reason, a roughness of the end surface 24 can be reduced without performing a machining process, such as polishing or the like. In a case where the machining process is performed, the core 20 and the clad 30 may become damaged.

### Second Embodiment

A second embodiment will be described. The second embodiment differs from the first embodiment mainly in the configuration of the core.

### [Configuration of Optical Waveguide]

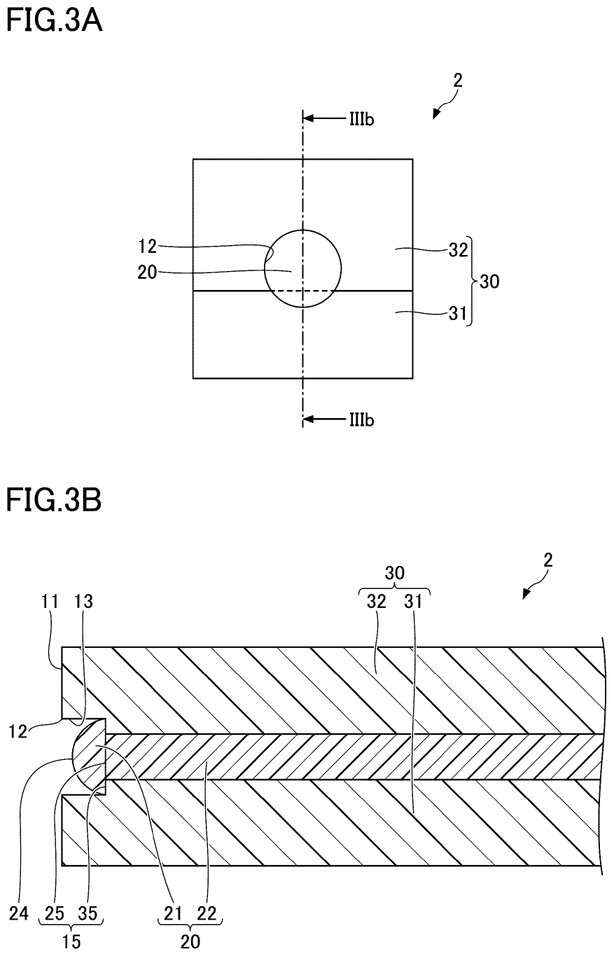

The configuration of the optical waveguide according to the second embodiment will be described. FIG. 3A and FIG. 3B are diagrams illustrating an example of the optical waveguide according to the second embodiment. FIG. 3A illustrates a side view of the optical waveguide, and FIG. 3B illustrates a cross sectional view of the optical waveguide. FIG. 3B corresponds to a cross sectional view taken along a line IIIb-IIIb in FIG. 3A.

As illustrated in FIG. 3A and FIG. 3B, in a polymer optical waveguide 2 according to the second embodiment, the core 20 includes a first portion 21 and a second portion 22. The first portion 21 is located inside the recess 12. The second portion 22 is connected to the first portion 21 on the side opposite to the first surface 11. The second portion 22 extends linearly, and has an end surface 25. The end surface 25 connects to the first portion 21. The first portion 21 includes an end surface 24 of the core 20. The end surface 24 is continuous with the sidewall surface 13 of the recess 12. The end surface 24 of the core 20 is exposed inside the recess 12. The end surface 24 is located at a position deeper than the first surface 11. At a boundary between the first portion 21 and the second portion 22, the second portion 22 is located on the inner side of the first portion 21 in the plan view from above in the direction perpendicular to the first surface 11. In the plan view from above in the direction perpendicular to the first surface 11, an equivalent circular diameter of the first portion 21 is greater than an equivalent circular diameter of the second portion 22.

The bottom surface 15 of the recess 12 include the end surface 25, and a surface 35 of the cladding 30 continuous with the end surface 25. Similar to the first embodiment, the end surface 24 is preferably a convex surface. The bottom surface 15 of the recess 12 may be a convex surface or a flat surface.

Otherwise, the configuration of the second embodiment is the same as that of the first embodiment. The second embodiment can also obtain effects that are the same as the effects obtainable by the first embodiment.

### [Method for Manufacturing Optical Waveguide]

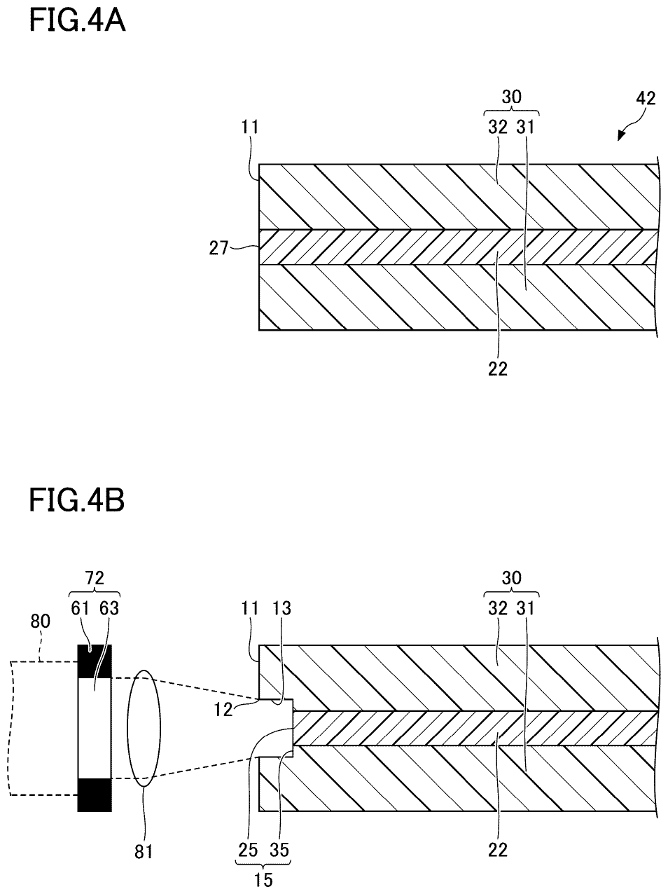

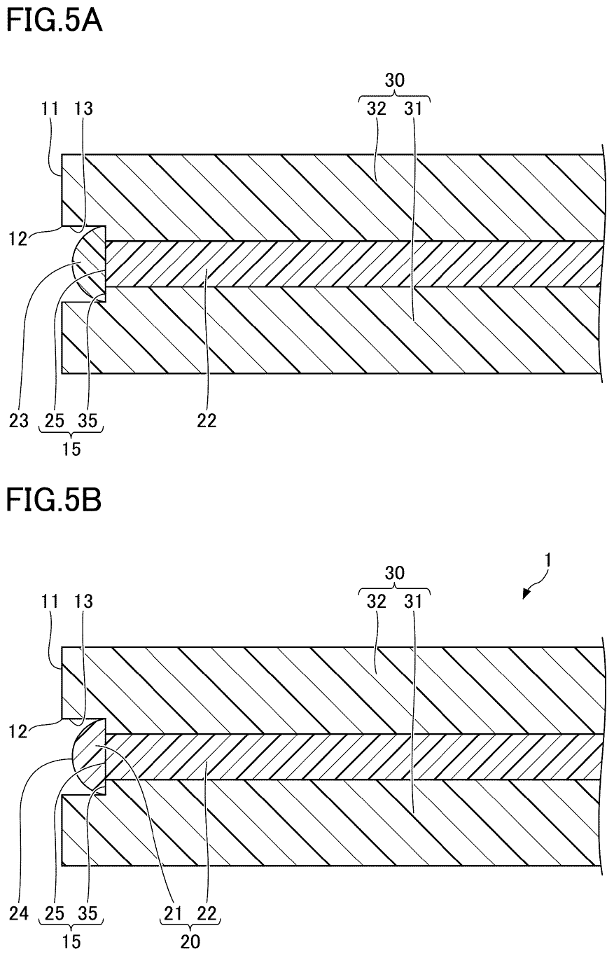

A method for manufacturing the polymer optical waveguide 2 will be described. FIG. 4A, FIG. 4B, FIG. 5A, and FIG. 5B are cross sectional views illustrating the method for manufacturing the optical waveguide according to the second embodiment.

First, as illustrated in FIG. 4A, an intermediate structure 42, including the cladding 30 having the first surface 11 and the second portion 22 having a second surface 27, is formed. The second portion 22 is an example of the core. Specifically, the second portion 22 is formed on the first cladding layer 31, and the second cladding layer 32 is formed on the first cladding layer 31 and the second portion 22. In the intermediate structure 42, the cladding 30 is provided around the second portion 22. For example, the first surface 11 and the second surface 27 coincide with each other.

Next, as illustrated in FIG. 4B, the recess 12 is formed in the intermediate structure 42. When forming the recess 12, the first surface 11 and the second surface 27 are irradiated with the laser beam 80 through a glass mask 72 and the convex lens 81. For example, an excimer laser beam is used for the laser beam 80. The glass mask 72 includes an annular optically opaque portion 61, and an optically transparent portion 63 on an inner side of the opaque portion 61. A light transmittance is uniform in the transparent portion 63. The first surface 11 and the second surface 27 are irradiated with the laser beam 80 through the glass mask 72 and the convex lens 81, thereby forming the recess 12 having a flat bottom surface 15. For example, the laser beam 80 is irradiated on the entire second surface 27 and on a portion of the first surface 11.

Thereafter, as illustrated in FIG. 5A, a liquid resin material 23 that becomes the first portion 21 is coated on the bottom surface 15 of the recess 12. A surface of the resin material 23 becomes convex due to surface tension.

Next, as illustrated in FIG. 5B, the resin material 23 is cured to form the first portion 21 having the end surface 24. If the resin material 23 is an ultraviolet curable resin, the resin material 23 can be cured by irradiating the resin material 23 with ultraviolet light.

The polymer optical waveguide 2 according to the second embodiment can be manufactured by the processes described above.

According to this manufacturing method, the first portion 21 having the end surface 24 is formed by curing the resin material 23. For this reason, the roughness of the end surface 24 can be reduced without performing a machining process, such as polishing or the like. The glass mask 72 has a structure simpler than the structure of the glass mask 71. Accordingly, the glass mask 72 is easier to form than the glass mask 71.

Even in a case where the resin material 23 is formed to protrude from the first surface 11, the end surface 24 of the core 20 can be prevented from coming into contact with the optical fiber, by providing a spacer between the cladding 30 and the support member (glass support member) or the like of the optical fiber. In this case, it is also possible to reduce the roughness of the end surface 24.

### Third Embodiment

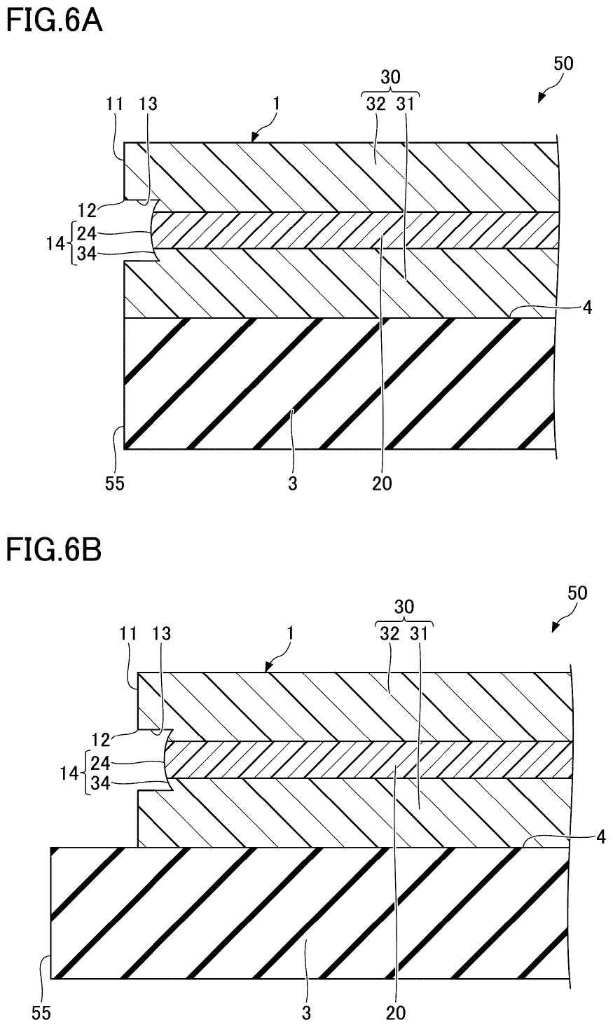

A third embodiment will be described. The third embodiment relates to an optical waveguide component. FIG. 6A and FIG. 6B are cross sectional views illustrating an example of the optical waveguide component according to the third embodiment.

As illustrated in FIG. 6A, an optical waveguide component 50 according to the third embodiment includes a substrate 3, and the polymer optical waveguide 1 according to the first embodiment. The substrate 3 has a principal surface 4, and the polymer optical waveguide 1 is provided on the principal surface 4. The first cladding layer 31 is in contact with the principal surface 4. The substrate 3 has a third surface 55 which coincides with the first surface 11. The substrate 3 is a printed circuit board, for example. An optoelectronic device or component configured using silicon photonics may be mounted on the substrate 3. The optoelectronic device or component may be optically coupled to the polymer optical waveguide 1.

The optical waveguide component 50 according to the third embodiment includes the polymer optical waveguide 1, and can thus obtain a high coupling efficiency between the polymer optical waveguide 1 and the optical fiber.

As illustrated in FIG. 6B, a third surface 55 of the substrate 3 may protrude from the first surface 11. In this example, it is difficult to reduce the roughness of the first surface 11 by polishing, but the end surface 24 having a low roughness can be obtained by irradiation with the laser beam 80.

In the third embodiment, the polymer optical waveguide 2 may be used in place of the polymer optical waveguide 1.

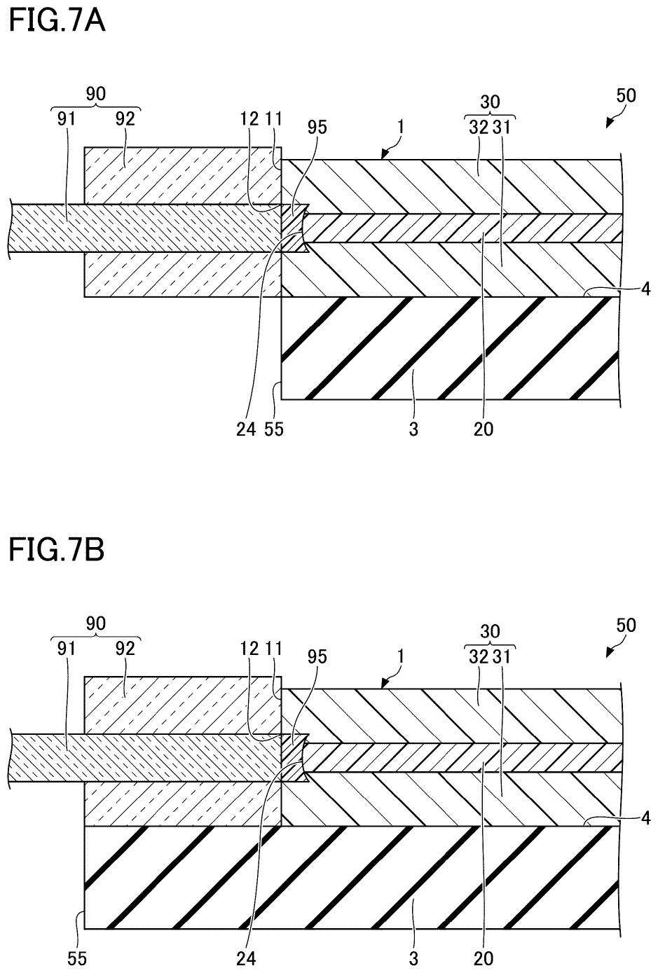

Next, an example of use of the optical waveguide component 50 according to the third embodiment will be described. FIG. 7A and FIG. 7B are cross sectional views illustrating an example of use of the optical waveguide component 50 according to the third embodiment.

As illustrated in FIG. 7A and FIG. 7B, the optical waveguide component 50 is used by connecting an optical fiber component 90 to the optical waveguide component 50. The optical fiber component 90 includes an optical fiber 91, and an optical connector 92, for example. The optical connector 92 includes a glass block, for example. The optical fiber 91 and the core 20 are optically coupled. The optical connector 92 is in contact with the first surface 11, but the optical fiber 91 is separated from the end surface 24 of the core 20. For example, the optical connector 92 is fixed to the optical waveguide component 50 by a latch mechanism or the like. An optically transparent (or light transmitting) adhesive 95 may be provided between the optical fiber 91 and the core 20. In a case where the optical waveguide component 50 includes a plurality of cores 20 and the optical fiber component 90 includes a plurality of optical fibers 91, a fiber array may be used as the optical fiber component 90, for example.

As illustrated in FIG. 7A, in the case where the optical waveguide component 50 illustrated in FIG. 6A is used, the optical fiber component 90 does not need to be in contact with the substrate 3. As illustrated in FIG. 7B, in the case where the optical waveguide component 50 illustrated in FIG. 6B is used, the optical fiber component 90 is in contact with the principal surface 4 of the substrate 3. The optical fiber component 90 may be mounted on the principal surface 4.

According to the embodiments of the present disclosure, a high coupling efficiency can be obtained between an optical waveguide and an optical fiber.

Various aspects of the subject-matter described herein may be set out non-exhaustively in the following numbered clauses:

1. A method for manufacturing a polymer optical waveguide, comprising:
forming an intermediate structure including a cladding having a first surface, and a core having a second surface, the cladding being provided around the core; and
forming a recess in the intermediate structure by irradiating the first surface and the second surface with a laser beam, wherein:
an end surface of the core is exposed inside the recess, and
the end surface is located at a position deeper than the first surface.

2. The method for manufacturing the polymer optical waveguide according to clause 1, wherein the end surface is a convex surface.

3. The method for manufacturing the polymer optical waveguide according to clause 1 or 2, wherein:
in a plan view from above in a direction perpendicular to the first surface, the end surface is separated from a sidewall surface of the recess and is located on an inner side of the sidewall surface.

Although the embodiments are numbered with, for example, “first,” “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A polymer optical waveguide comprising:
a core having an end surface; and
a cladding provided around the core and having a first surface, wherein:
a recess is formed in the first surface,
the end surface is exposed inside the recess, and
the end surface is located at a position deeper than the first surface.

2. The polymer optical waveguide as claimed in claim 1, wherein the end surface is a convex surface.

3. The polymer optical waveguide as claimed in claim 1, wherein:
in a plan view from above in a direction perpendicular to the first surface, the end surface is separated from a sidewall surface of the recess and is located on an inner side of the sidewall surface.

4. The polymer optical waveguide as claimed in claim 1, wherein the recess has a bottom surface including:
the end surface, and
a second surface of the cladding,
wherein the second surface is continuous with the end surface.

5. The polymer optical waveguide as claimed in claim 1, wherein:
the recess has a sidewall surface, and
the end surface is continuous with the sidewall surface.

6. The polymer optical waveguide as claimed in claim 1, wherein
the core includes a first portion located inside the recess, and a second portion connected to the first portion, and
in a plan view from above in a direction perpendicular to the first surface, the second portion is located on an inner side of the first portion at a boundary between the first portion and the second portion.

7. An optical waveguide component comprising:
a substrate having a principal surface; and
the polymer optical waveguide according to claim 1 provided on the principal surface.

8. An optical waveguide component comprising:
a substrate having a principal surface; and
the polymer optical waveguide according to claim 2 provided on the principal surface.
